(19) United States
(12) Patent Application Publication
(10) Pub. No.: US 2024/0099204 A1
(43) Pub. Date: Mar. 28, 2024

(54) MULTIFUNCTIONAL FINE CULTIVATION DEVICE

(71) Applicant: Zhenkun Wang, Cambridge, MA (US)

(72) Inventor: Zhenkun Wang, Cambridge, MA (US)

(21) Appl. No.: 18/098,484

(22) Filed: Jan. 18, 2023

(30) Foreign Application Priority Data
Sep. 25, 2022 (CN) 202222532164.1

(51) Int. Cl. A01G 13/10; A01G 9/02; A01G 9/24; A01G 22/05

(52) U.S. Cl. CPC A01G 13/10; A01G 9/02; A01G 9/243; A01G 9/247; A01G 9/249; A01G 22/05

(57) ABSTRACT

A multifunctional fine cultivation device includes power grid, column, solar panel, circular container, fluorescent lamp, inset sticking board, and irrigation port. The container on the lowest side of the device is adapted to accommodate sands, and the middle of the container has the column, the top end of which is provided with the power grid; the upper side of the container is provided with the solar panel with a shape of high peripheral and low middle; the solar panel is in electric connection with the power grid, allowing the power grid to have low voltage for repelling birds; the solar panel has an inclined angle allowing rain water to flow into and be collected in the container; water can also penetrate into the ground through the feet, and the irrigation port can realize precision irrigation, and fluorescent lamps and inset sticking board attract and stick insets.

### CROSS REFERENCE TO RELATED APPLICATION

This application claims the benefits of Chinese application Serial No. 202222532164.1, filed on Sep. 25, 2022, the disclosures of which are incorporated by references herein in its entirety.

### TECHNICAL FIELD

The present invention relates to an agricultural equipment field, and more particularly to a multifunctional precision cultivation device.

### BACKGROUND

In recent years, organic agriculture has always been the trend of agricultural development, but the high management costs in the planting process, high labor costs such as bird repellent and insect repellent, low yield, and reduced farmers' income have been the main factors that plague its development and growth. The device of the present invention reduces the cost of fine management in organic agriculture, saves time and effort, and when planting economic crops such as fruit trees, one-time installation can have the effects of drought solving, watering, moisturizing, weeding, insect repelling, and bird repelling, increase the local temperature of crops, increase production, and reduce labor costs and management difficulties.

### SUMMARY

To improve the variety and quality of planted products, to repel birds and insects in a green and environmentally friendly way, to ensure the irrigation of fruit trees, to reduce the cost of refined management and to increase production, the present invention is proposed. An object of the present invention is to a multifunctional fine cultivation device, powering a bird repelling device through a solar panel, using week voltage to repel bird, covering the soil surface around a fruit tree to block sunlight with the solar panel to inhibit weed growth, allowing rain water to flow into a circular container through a inclined angle of the solar panel, thereby collecting the rain water, and to slowly penetrate into the ground through the feet of the container, realizing precision irrigation through n irrigation port of the container, and attracting insets by a circle of fluorescent lamps on the peripheral of the solar panel and sticking them on an inset sticking board provided on the back surface of the solar panel. Whereby, the device of the present invention integrates the functions of repelling birds, collecting water, irrigating, reducing evaporation, etc.

To achieve the above object, the present invention provides the following technical solutions:
a multifunctional fine cultivation device includes power grid, column, solar panel, circular container, rechargeable battery, fluorescent lamp, inset sticking board, irrigation port,
where the bottom of the circular container on the lowest side of the device is hollow, the inner edge of the container extends upwards and is slightly lower than the outer edge thereof, the inner space thereof is adapted to store sands up to a half height of the container, the container is made by splicing two semicircular container bodies for convenience of installation to form a two-lobed container, the lower surface of the circular container is provided with a plurality of hollow feet used to communicate the circular container with the ground, so that rain water collected in the container slowly penetrates into the ground to irrigate underground plant roots, and an irrigation port is configured on the circular container for convenience of carrying out precision irrigation and reduction of water resource waste.
where the upper side of the circular container of the device is provided with the circular solar panel covering and exceeding the outer edge of the circular container; the solar panel is form by splicing a plurality of fan-shaped solar panel sheets and similar to unfolded petals, and there is a certain gap between two adjacent fan-shaped solar panel sheets, from which water can flow into the circular container below; the solar panel has the shape of high peripheral and low middle and is inclined toward the center of the circular container, allowing rain water dropping on the circular solar panel to flow into the circular container and be absorbed by the sands accommodated therein, conducive to collecting rain water; rain water can also slowly penetrate into the ground to the underground plant roots through the hollow feet, so as to have the effect of plant irrigation, and the solar panel blocks the ground from sunlight, thereby reducing the growth of weeds.
where the middle of the circular container is accommodated with the hollow square column and allows a plant vine to pass through, and the bottom end of the column is inserted into the ground and the top end thereof is connected with the power grid; electric energy generated from the solar panel is transmitted to the power grid through an electric wire, allowing the electric grid to have low voltage for repelling birds; when birds stay on the power grid, they will be electrified by the power grid and fly away.
where the rechargeable battery is placed in the hollow column and respectively in connection with the solar panel and power grid; when there is sunshine, excessive electric energy is stored therein; when there is no sunshine, the rechargeable battery is used to provide electric energy to the power grid for repelling birds.
where the power grid is grid-shaped and slightly larger than the square column, and the size of the lattice thereof can be adjusted according to the kind of plant to be grown and the type of bird to be repelled, so as to ensure that one paw of the bird steps on the positive and negative poles of the power grid at the same time to repel birds under the stimulation of weak electricity on the power grid.
where the outer peripheral of each of fan-shaped solar panel sheets adapted to form the solar panel is installed with a circle of fluorescent lamp, and the back surface thereof has the inset sticking boards, and small insets attracted by the fluorescent lamps are stuck on the inset sticking boards.

### BRIEF DESCRIPTION OF THE DRAWINGS

FIG. 1 is an appearance view of a multifunctional fine cultivation device of a preferred embodiment of the present invention;

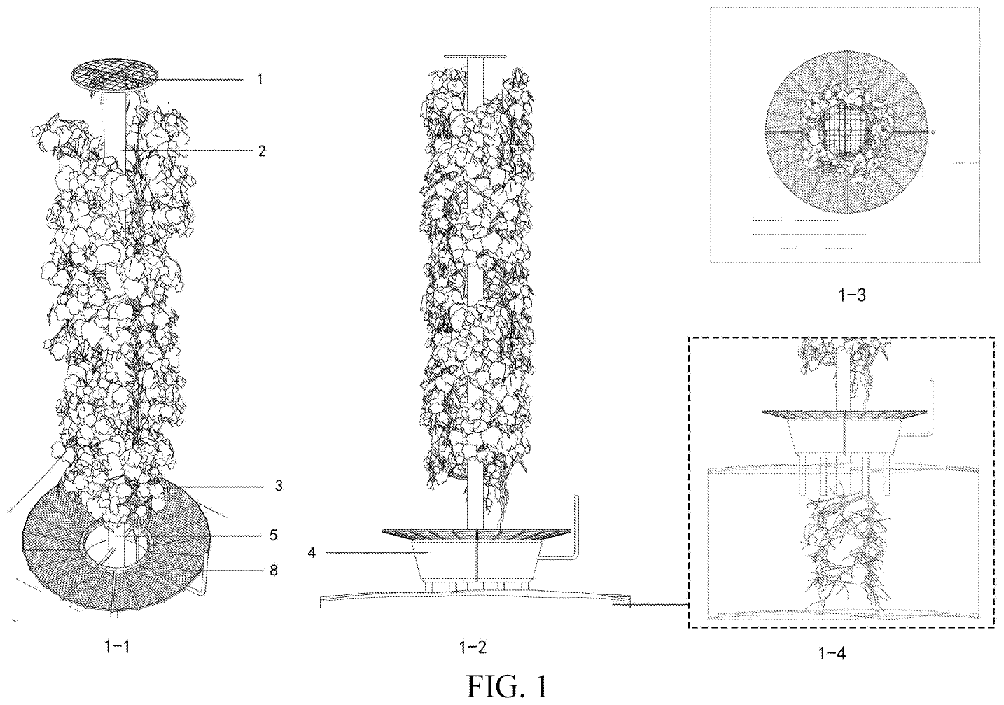

FIG. 2 is a structural schematic view of the lower-half part of the multifunction fine cultivation device of the embodiment of the present invention; and

FIG. 3 is a structural schematic view of the upper-half part of the multifunction fine cultivation device of the embodiment of the present invention,

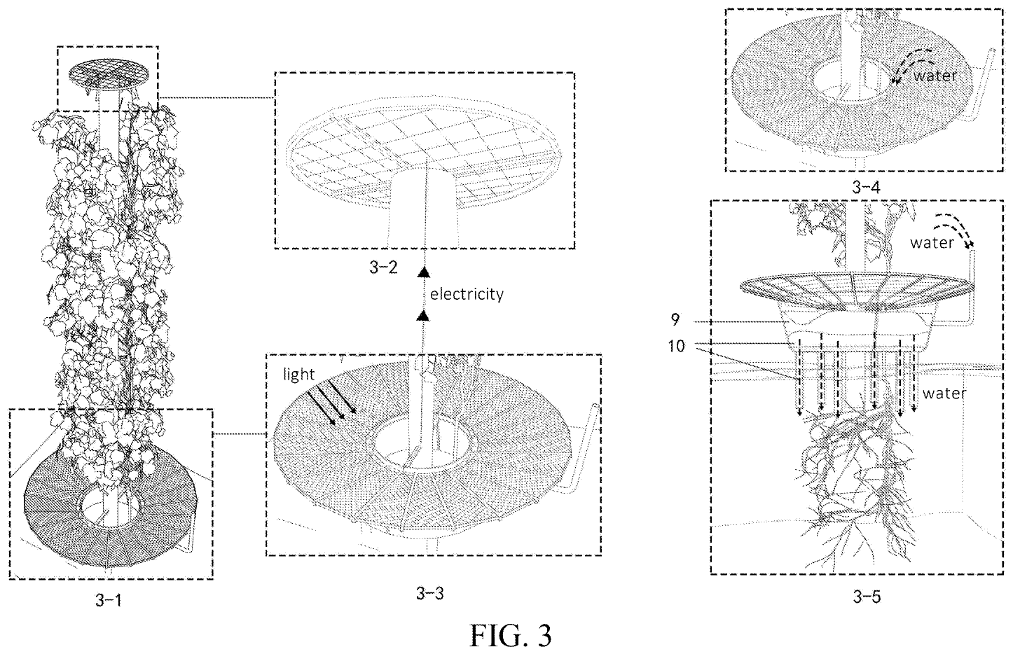

where the reference numbers in the drawings are: 1: power grid; 2: column; 3: solar panel; 4: circular container; 5; rechargeable battery; 6: fluorescent lamp; 7: inset sticking board; 8: irrigation port.

### DETAILED DESCRIPTION

The following embodiments will further describe a multifunctional fine cultivation device of the present invention in detail in conjunction with the accompanying drawings. Obviously, the described embodiments are only some of the embodiments of the present invention, not all of them. Based on the embodiments of the present invention, all other embodiments obtained by persons of ordinary skill in the art without making creative efforts belong to the protection scope of the present invention.

A multifunctional fine cultivation device of the present invention, in a preferred embodiment, includes power grid, column, solar panel, circular container, rechargeable battery, fluorescent lamp, insect sticking board, and irrigation port.

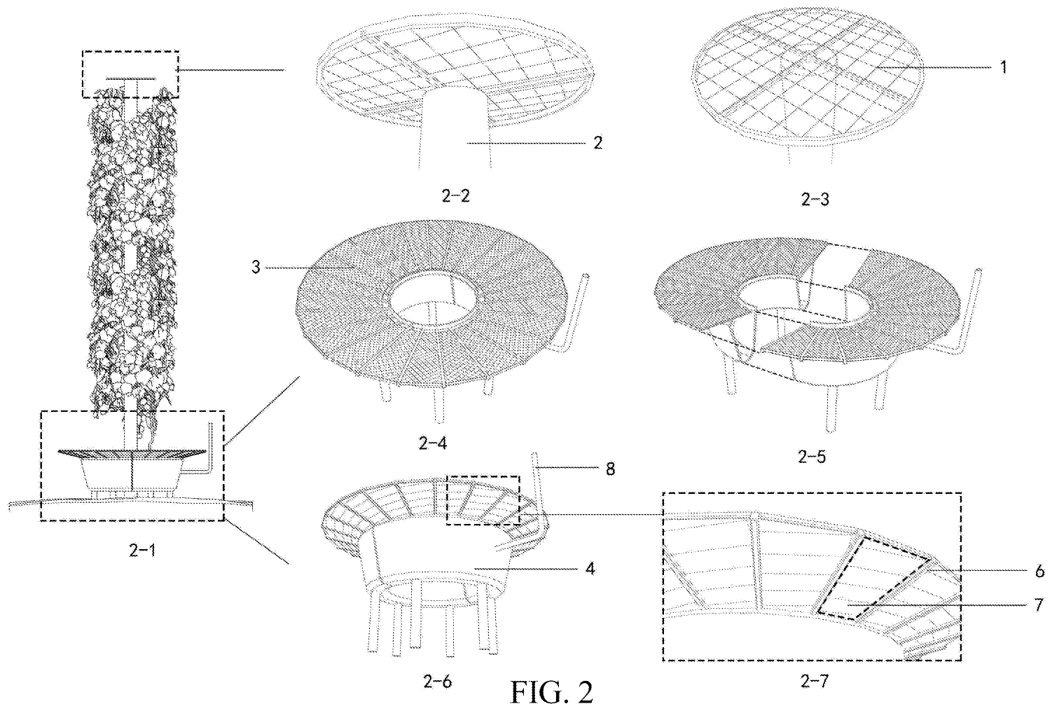

Referring to FIG. 2, in which the multifunctional fine cultivation device is shown, taking planting a grapevine as an example, the grapevine is planted in soil, a square column 2 is inserted beside the grapevine and adjacent to the stem, a two-lobed circular container 4 is used to enclose the stem of the grapevine and column 2, the circular container 4 is provided with a plurality of hollow feet inserted into the ground, which communicate the circular container 4 with the ground, the mouth of the circular container 4 is covered with the circular solar panel 3, which is formed by splicing multiple fan-shaped solar panels, the top end of the column 2 is provided with a power grid 1, which is connected with the solar panel 3 and the rechargeable battery 5 placed in the column 2.

The circular container 4 is made by splicing two semicircular container bodies for easy installation to form the two-lobed container, and the internal space of the circular container 4 is adapted to accommodate sands up to a half height of the circular container. Furthermore, the plurality of hollow feet are provided on the lower surface of the circular container 4, allowing the inner part of the circular container 4 to be in communication with the ground; water stored in the circular container 4 is absorbed by the sands, and can slowly penetrate into the ground and flow to underground plant roots through the hollow feet, thereby irrigating the plant. Furthermore, the irrigation port 8 is provided on the circular container 4.

The circular solar panel 3 is completely covered on the mouth of the circular container 4 and has the shape of high peripheral and low middle; when it rains, rain water dropping on the solar panel 3 can flow into the circular container 4 and is fully absorbed by the sands, and more water can flow into the ground through the feet of the circular container 4; when there is not enough rain, water evaporation is reduced because the circular container 4 is relatively closed and there is no direct sunlight, and the kept water is used for the plant to absorb; when it is more dry, the plant can be watered through the irrigation port 8, so as to have the effects of water regulation and precision irrigation. Furthermore, since the circular container 4 and solar panel 3 also block the soil around the grapevine roots from sunlight, which inhibits the growth of weeds to a certain extent, so that the grapevine grows better.

The square column 2 passed through the middle of the circular container 4 allows the grapevine to attach and climb on it. The top end of the column 2 is provided with the power grid 1, and the electric energy generated from the solar panel 3 is transmitted to the power grid, making the power grid 1 have low voltage; when birds stay on the power grid 1, they will be electrified and fly away, thereby ensuring the yield and quality of grapes. Furthermore, the solar panel 3 is also connected with the rechargeable battery 5; when there is sunshine, the excess electric energy is stored in the rechargeable battery 5, and when there is no sunshine, the rechargeable battery 5 provides electric energy to the power grid 1 to repel birds.

A circle of fluorescent lamp 6 is installed on the peripheral of each of the fan-shaped solar panel sheets used to form the solar panel 3, and the back surface of the solar panel 3 is provided with inset sticking boards 7, so that small insets attracted by the fluorescent lamps 6 will be stuck on the inset sticking boards 7.

Naturally, the device can also be applied to other fruit trees or economic corps. The specific embodiments described herein are intended to be illustrative of the invention only. Those skilled in the art to which the present invention pertains may make various modifications or supplements to the described specific embodiments or replace them in similar ways without departing from the protection scope of the present invention.

What is claimed is:

1. A multifunctional fine cultivation device, comprising power grid, column, solar panel, circular container, rechargeable battery, fluorescent lamp, inset sticking board, irrigation port, characterized in that said multifunctional fine cultivation device is mainly used for the cultivation of fruit trees or other suitable crops, integrating functions such as repelling birds, collecting water, irrigating, reducing evaporation, moisturizing.

2. The device according to claim 1, wherein the bottom of said circular container on the lowest side of said device is hollow, the inner edge of said container extends upwards and is slightly lower than the outer edge thereof, the inner space thereof is adapted to store sands up to a half height of said container, said container is made by splicing two semicircular container bodies for convenience of installation to form a two-lobed container, the lower surface of said circular container is provided with a plurality of hollow feet used to communicate said circular container with the ground, so that rain water collected in said container slowly penetrates into the ground to irrigate underground plant roots, and an irrigation port is configured on said circular container for convenience of carrying out precision irrigation and reduction of water resource waste.

3. The device according to claim 1, wherein the upper side of said circular container of said device is provided with said circular solar panel covering and exceeding the outer edge of said circular container; said solar panel is form by splicing a plurality of fan-shaped solar panel sheets and similar to unfolded petals, and there is a certain gap between two adjacent fan-shaped solar panel sheets, from which water can flow into said circular container below; said solar panel has the shape of high peripheral and low middle and is inclined toward the center of said circular container, allowing rain water dropping on said circular solar panel to flow into said circular container and be absorbed by said sands accommodated therein, conducive to collecting rain water; rain water can also slowly penetrate into the ground to said underground plant roots through said hollow feet, so as to have the effect of plant irrigation, and said solar panel blocks the ground from sunlight, thereby reducing the growth of weeds.

4. The device according to claim 1, wherein the middle of said circular container is accommodated with said hollow square column and allows a plant vine to pass through, and the bottom end of said column is inserted into the ground and the top end thereof is connected with said power grid; electric energy generated from said solar panel is transmitted to said power grid through an electric wire, allowing said electric grid to have low voltage for repelling birds; when birds stay on said power grid, they will be electrified by said power grid and fly away.

5. The device according to claim 1, wherein said rechargeable battery is placed in said hollow column and respectively in connection with said solar panel and power grid; when there is sunshine, excessive electric energy is stored therein; when there is no sunshine, said rechargeable battery is used to provide electric energy to said power grid for repelling birds.

6. The device according to claim 1, wherein said power grid is grid-shaped and slightly larger than said square column, and the size of the lattice thereof can be adjusted according to the kind of plant to be grown and the type of bird to be repelled, so as to ensure that one paw of the bird steps on the positive and negative poles of the power grid at the same time to repel birds under the stimulation of weak electricity on said power grid.

7. The device according to claim 1, wherein the outer peripheral of each of fan-shaped polar panel sheets adapted to form said is installed with a circle of fluorescent lamp, and the back surface thereof has said inset sticking boards, and small insets attracted by said fluorescent lamps are stuck on said inset sticking boards.
